(19) United States
(12) Patent Application Publication
(10) Pub. No.: US 2023/0188714 A1
(43) Pub. Date: Jun. 15, 2023

(54) IMAGE ENCODING/DECODING METHOD AND DEVICE FOR SIGNALING APS IDENTIFIER, AND COMPUTER-READABLE RECORDING MEDIUM IN WHICH BITSTREAM IS STORED

(71) Applicant: LG ELECTRONICS INC, Seoul (KR)

(72) Inventors: Hendry HENDRY, Seoul (KR); Seung Hwan KIM, Seoul (KR); Jung Hak NAM, Seoul (KR); Hyeong Moon JANG, Seoul (KR); Seethal PALURI, Seoul (KR)

(21) Appl. No.: 17/925,782

(22) PCT Filed: Jun. 9, 2021
(86) PCT No.: PCT/KR2021/007193

§ 371 Date: Nov. 16, 2022

Related U.S. Application Data
(60) Provisional application No. 63/037,574, filed on Jun. 10, 2020.

(51) Int. Cl. H04N 19/117; H04N 19/186; H04N 19/82

(52) U.S. Cl. CPC H04N 19/117; H04N 19/82; H04N 19/186

(57) ABSTRACT

An image encoding/decoding method and apparatus for signaling an identifier for an APS and a method of transmitting a bitstream are provided. The image decoding method according to the present disclosure may comprise obtaining adaptive parameter set (APS) parameter type information specifying an APS parameter type signaled by an APS, obtaining APS identifier information specifying the APS after obtaining the APS parameter type information, and reconstructing an image based on the APS identifier information.

### TECHNICAL FIELD

The present disclosure relates to an image encoding/decoding method and apparatus, and, more particularly, to an image encoding and decoding method and apparatus for signaling an identifier for an adaptive parameter set (APS), and a recording medium storing bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus for improving encoding/decoding efficiency by efficiently signaling an identifier for an APS.

Another object of the present disclosure is to provide method of transmitting a bitstream generated by an image encoding method or apparatus according to the present disclosure.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

The technical problems solved by the present disclosure are not limited to the above technical problems and other technical problems which are not described herein will become apparent to those skilled in the art from the following description.

### Technical Solution

An image decoding method performed by an image decoding apparatus according to an aspect of the present disclosure may comprise obtaining adaptive parameter set (APS) parameter type information specifying an APS parameter type signaled by an APS, obtaining APS identifier information specifying the APS after obtaining the APS parameter type information, and reconstructing an image based on the APS identifier information.

In the image decoding method according to the present disclosure, based on a value of the APS parameter type information being 0, the APS parameter type may be determined to be an all loop filter (ALF) parameter type.

In the image decoding method according to the present disclosure, based on a value of the APS parameter type information being 1, the APS parameter type may be determined to be a luma mapping with chroma scaling (LMCS) parameter type.

In the image decoding method according to the present disclosure, based on a value of the APS parameter type information being 2, the APS parameter type may be determined to be a scaling list parameter type.

In the image decoding method according to the present disclosure, based on the APS parameter type being an all loop filter (ALF) parameter or a scaling list parameter, an APS identifier may be determined to be a value in a range from 0 to 7.

In the image decoding method according to the present disclosure, based on the APS parameter type being a luma mapping with chroma scaling (LMCS) parameter, an APS identifier may be determined to be a value in a range from 0 to 3.

An image decoding apparatus according to another aspect of the present disclosure may comprise a memory and at least one processor. The at least one processor may obtain adaptive parameter set (APS) parameter type information specifying an APS parameter type signaled by an APS, obtain APS identifier information specifying the APS after obtaining the APS parameter type information, and reconstruct an image based on the APS identifier information.

An image encoding method performed by an image encoding apparatus according to another aspect of the present disclosure may comprise determining an adaptive parameter set (APS) parameter type, determining an APS identifier specifying the APS based on the APS parameter type, encoding APS identifier information specifying the APS identifier after encoding the APS parameter type information specifying the APS parameter type, and encoding an image based on the APS identifier information.

In the image encoding method according to the present disclosure, based on the APS parameter type being an all loop filter (ALF) parameter, a value of the APS parameter type information specifying the APS parameter type may be determined to be 0.

In the image encoding method according to the present disclosure, based on the APS parameter type being a luma mapping with chroma scaling (LMCS) parameter, a value of the APS parameter type information specifying the APS parameter type may be determined to be 1.

In the image encoding method according to the present disclosure, based on the APS parameter type being a scaling list parameter, a value of the APS parameter type information specifying the APS parameter type may be determined to be 2.

In the image encoding method according to the present disclosure, based on the APS parameter type being an all loop filter (ALF) parameter or a scaling list parameter, an APS identifier may be determined to be a value in a range from 0 to 3.

In the image encoding method according to the present disclosure, based on the APS parameter type being a luma mapping with chroma scaling (LMCS) parameter, an APS identifier may be determined to be a value in a range from 0 to 7.

In addition, a computer-readable recording medium according to another aspect of the present disclosure may store the bitstream generated by the image encoding apparatus or the image encoding method of the present disclosure.

In a transmission method according to another aspect of the present disclosure, a bitstream generated by an image encoding method or an image encoding apparatus of the present disclosure may be transmitted.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an image encoding/decoding method and apparatus for improving encoding/decoding efficiency by efficiently signaling an identifier for an APS.

Also, according to the present disclosure, it is possible to provide a method of transmitting a bitstream generated by an image encoding method or apparatus according to the present disclosure.

Also, according to the present disclosure, it is possible to provide a recording medium storing a bitstream generated by an image encoding method or apparatus according to the present disclosure.

Also, according to the present disclosure, it is possible to provide a recording medium storing a bitstream received, decoded and used to reconstruct an image by an image decoding apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus, to which an embodiment of the present disclosure is applicable.

FIG. 4 shows an example of a schematic picture decoding procedure, to which embodiment(s) of the present disclosure is applicable.

FIG. 5 shows an example of a schematic picture encoding procedure, to which embodiment(s) of the present disclosure is applicable.

FIG. 6 is a view illustrating an example of a layer structure for a coded image/video.

FIG. 7 is a view illustrating an example of a syntax structure for signaling information on an APS and a picture header.

FIGS. 8 to 16 are view illustrating a VPS to which an embodiment according to the present disclosure is applicable.

FIGS. 17 to 18 are views illustrating a VPS to which an embodiment according to the present disclosure is applicable.

FIG. 19 is a view illustrating a method of decoding an image by an image decoding apparatus according to an embodiment.

FIG. 20 is a view illustrating a method of encoding an image by an image encoding apparatus according to an embodiment.

FIG. 21 is a view illustrating an APS parameter name according to an APS parameter type.

FIG. 22 is a view illustrating an example of a syntax structure for signaling APS identifier information according to an APS parameter type.

FIG. 23 is a view illustrating operation of the image encoding apparatus according to the embodiment described with reference to FIG. 22.

FIG. 24 is a view illustrating operation of an image decoding apparatus according to the embodiment described with reference to FIG. 22.

FIG. 25 is a view illustrating a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, “A or B” may mean “only A”, “only B” or “both A and B”. In other words, in the present disclosure, “A or B” may be interpreted as “A and/or B”. For example, in the present disclosure, “A, B or C” may mean “only A, “only B”, “only C” or “any combination of A, B and C”.

A slash (/) or comma used in the present disclosure may mean “and/or”. For example, “A/B” may mean “A and/or B”. Therefore, “A/B” may mean “only A”, “only B” or “both A and B”. For example, “A, B, C” may mean “A, B or C”.

In addition, in the present disclosure, “at least one of A, B and C” may mean “only A”, “only B”, “only C” or “any combination of A, B and C”. In addition, in the disclosure, “at least one of A, B or C” or “at least one of A, B and/or C” may be interpreted as being the same as “at least one of A, B and C”.

In addition, in the present disclosure, “at least one of A, B and C” means “only A”, “only B”, “only C”, or “A, any combination of A, B and C”. Also, “at least one of A, B or C” or “at least one of A, B and/or C” means may mean “at least one of A, B and C”.

In addition, parentheses used in the present disclosure may mean “for example”. Specifically, when “prediction (intra prediction)” is described, “intra prediction” may be proposed as an example of “prediction”. In other words, “prediction” of the present disclosure is not limited to “intra prediction” and “intra prediction” may be proposed as an example of “prediction”. In addition, even when “prediction (that is, intra prediction)” is described, “intra prediction” may be proposed as an example of “prediction”.

In the present disclosure, technical features individually described in one drawing may be implemented individually or simultaneously.

### Overview of Video Coding System

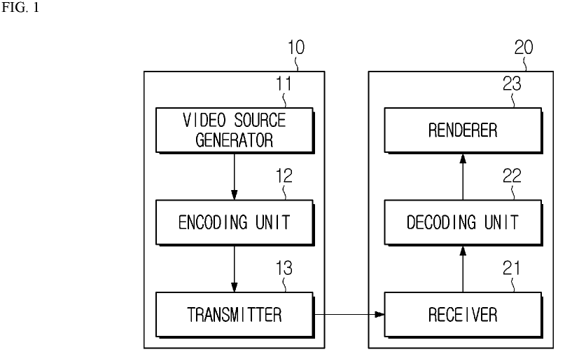

FIG. 1 is a view illustrating a video coding system according to the present disclosure.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

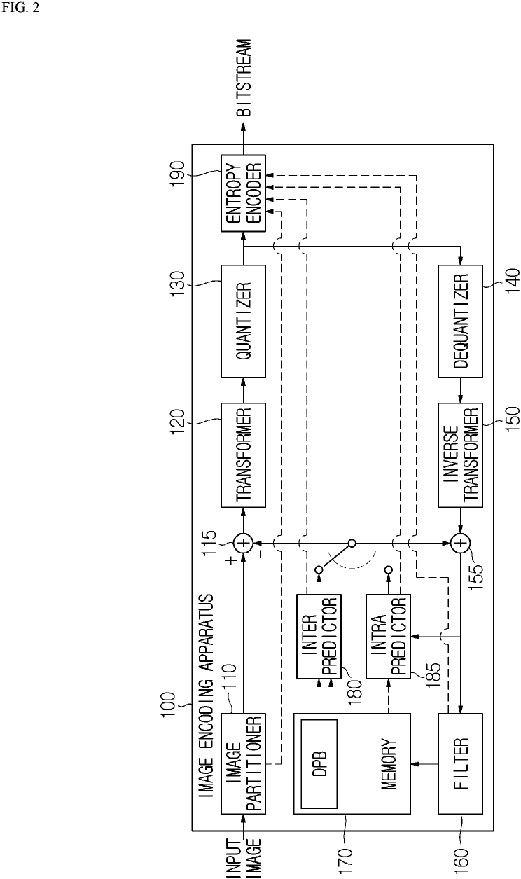

FIG. 2 is a view schematically illustrating an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The predictor (the inter predictor 180 or the intra predictor 185) may perform prediction on a block to be processed (current block) and generate a predicted block including prediction samples for the current block. The predictor may determine whether intra prediction or inter prediction is applied on a current block or CU basis. The predictor may generate various information related to prediction of the current block and transmit the generated information to the entropy encoder 190. The information on the prediction may be encoded in the entropy encoder 190 and output in the form of a bitstream.

The intra predictor 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 185 may determine the prediction mode applied to the current block by using a prediction mode applied to a neighboring block.

The inter predictor 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter predictor 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The predictor may generate a prediction signal based on various prediction methods and prediction techniques described below. For example, the predictor may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the predictor may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the predictor may be used to generate a reconstructed signal or to generate a residual signal. The subtractor 115 may generate a residual signal (residual block or residual sample array) by subtracting the prediction signal (predicted block or prediction sample array) output from the predictor from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loeve transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter predictor 180 or the intra predictor 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

Meanwhile, in a picture encoding and/or reconstruction process, luma mapping with chroma scaling (LMCS) is applicable.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter predictor 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter predictor 180. The memory 170 may store the motion information of the block from which the motion information in the current picture is derived (or encoded) and/or the motion information of the blocks in the picture that have already been reconstructed. The stored motion information may be transmitted to the inter predictor 180 and used as the motion information of the spatial neighboring block or the motion information of the temporal neighboring block. The memory 170 may store reconstructed samples of reconstructed blocks in the current picture and may transfer the reconstructed samples to the intra predictor 185.

### Overview of Image Decoding Apparatus

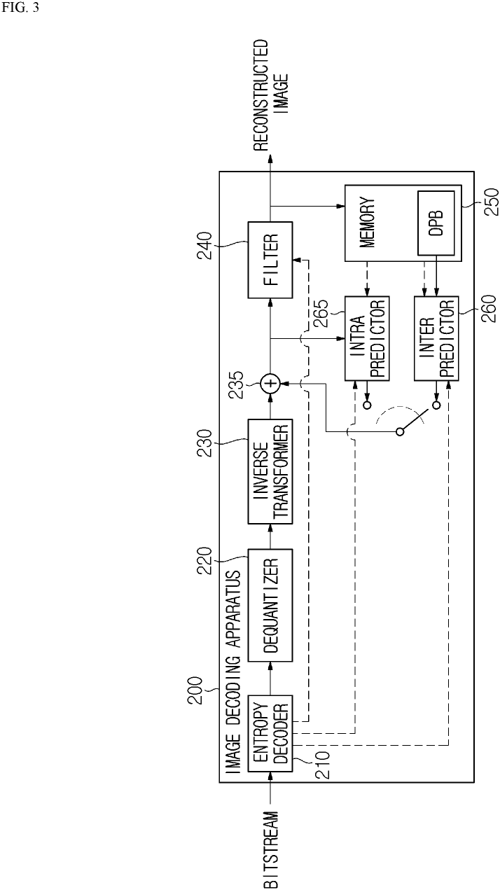

FIG. 3 is a view schematically illustrating an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively referred to as a “predictor”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the predictor (the inter predictor 260 and the intra predictor 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter predictor 160 or the intra predictor 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 210 and may determine a specific intra/inter prediction mode (prediction technique).

It is the same as described in the predictor of the image encoding apparatus 100 that the predictor may generate the prediction signal based on various prediction methods (techniques) which will be described later.

The intra predictor 265 may predict the current block by referring to the samples in the current picture. The description of the intra predictor 185 is equally applied to the intra predictor 265.

The inter predictor 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

Meanwhile, in a picture decoding process, luma mapping with chroma scaling (LMCS) is applicable.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter predictor 260. The memory 250 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 250 may store reconstructed samples of reconstructed blocks in the current picture and transfer the reconstructed samples to the intra predictor 265.

In the present disclosure, the embodiments described in the filter 160, the inter predictor 180, and the intra predictor 185 of the image encoding apparatus 100 may be equally or correspondingly applied to the filter 240, the inter predictor 260, and the intra predictor 265 of the image decoding apparatus 200.

The quantizer of the encoding apparatus may derive quantized transform coefficients by applying quantization to transform coefficients, and the dequantizer of the encoding apparatus or the dequantizer of the decoding apparatus may derive transform coefficients by applying dequantization to the quantized transform coefficients. In video coding, a quantization rate may be changed and a compression rate may be adjusted using the changed quantization rate. From an implementation point of view, a quantization parameter (QP) may be used instead of directly using the quantization rate in consideration of complexity. For example, a quantization parameter of an integer value from 0 to 63 may be used, and each quantization parameter value may correspond to an actual quantization rate. A quantization parameter QP_{Y} for a luma component (luma sample) and a quantization parameter QPc for a chroma component (chroma sample) may be differently set.

In the quantization process, a transform coefficient C may be input and divided by a quantization rate Qₛₜₑₚ, and a quantized transform coefficient C′ may be derived based on this. In this case, the quantization rate may be multiplied by a scale in consideration of computational complexity to form an integer and a shift operation may be performed by a value corresponding to the scale value. A quantization scale may be derived based on a product of the quantization rate and the scale value. That is, the quantization scale may be derived according to the QP. The quantization scale may be applied to the transform coefficient and the quantized transform coefficient C′ may be derived based on this.

A dequantization process is an inverse process of the quantization process, and the quantized transform coefficient C′ may be multiplied by the quantization rate Qₛₜₑₚ, and a reconstructed transform coefficient C″ may be derived based on this. In this case, a level scale may be derived according to the quantization parameter, the level scale may be applied to the quantized transform coefficient C″, and the reconstructed transform coefficient C″ may be derived based on this. The reconstructed transform coefficient C″ may be slightly different from an original transform coefficient C due to loss in a transform and/or quantization process. Accordingly, even in the encoding apparatus, dequantization may be performed in the same manner as in the decoding apparatus.

Meanwhile, adaptive frequency weighting quantization technology for adjusting quantization strength according to the frequency may be applied. Adaptive frequency weighting quantization technology may correspond to a method of differently applying the quantization strength according to the frequency. In adaptive frequency weighting quantization, the quantization strength may be differently applied according to the frequency using a predefined quantization scaling matrix. That is, the above-described quantization/dequantization process may be performed further based on the quantization scaling matrix.

For example, a different quantization scaling matrix may be used depending on the size of a current block and/or whether a prediction mode applied to the current block to generate a residual signal of the current block is inter prediction or intra prediction. The quantization scaling matrix may be referred to as a quantization matrix or a scaling matrix. The quantization scaling matrix may be predefined. In addition, for frequency adaptive scaling, frequency quantization scaling information for the quantization scaling matrix may be constructed/encoded in the encoding apparatus and signalled to the decoding apparatus. The frequency quantization scaling information may be referred to as quantization scaling information. The frequency quantization scale information may include scaling list data scaling_list_data.

The quantization scaling matrix may be derived based on the scaling list data. In addition, the frequency quantization scale information may include present flag information specifying whether the scaling list data is present. In addition, when the scaling list data is signalled at a high level (e.g., SPS), information specifying whether the scaling list data is modified at a lower level (e.g., PPS, APS or slice header, etc.) may be further included.

### General Image/video Coding Procedure

In image/video coding, a picture configuring an image/video may be encoded/decoded according to a decoding order. A picture order corresponding to an output order of the decoded picture may be set differently from the decoding order, and, based on this, not only forward prediction but also backward prediction may be performed during inter prediction.

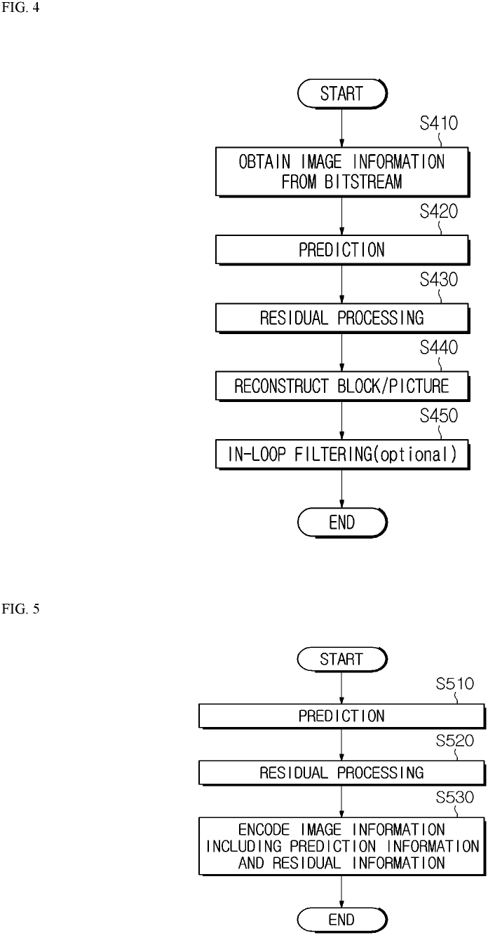

FIG. 4 shows an example of a schematic picture decoding procedure, to which embodiment(s) of the present disclosure is applicable.

Each procedure shown in FIG. 4 may be performed by the image decoding apparatus of FIG. 3. For example, in FIG. 4, step S410 may be performed by the entropy decoder 210, step S420 may be performed by a predictor including the intra predictor 265 and the inter predictor 260, step S430 may be performed by a residual processor including the dequantizer 220 and the inverse transformer 230, step S440 may be performed by the adder 235, and step S450 may be performed by the filter 240. Step S410 may include the information decoding procedure described in the present disclosure, step S420 may include the inter/intra prediction procedure described in the present disclosure, step S430 may include a residual processing procedure described in the present disclosure, step S440 may include the block/picture reconstruction procedure described in the present disclosure, and step S450 may include the in-loop filtering procedure described in the present disclosure.

Referring to FIG. 4, the picture decoding procedure may schematically include a procedure (S410) for obtaining image/video information (through decoding) from a bitstream, a picture reconstruction procedure (S420 to S440) and an in-loop filtering procedure (S450) for a reconstructed picture. The picture reconstruction procedure may be performed based on prediction samples and residual samples obtained through inter/intra prediction (S420) and residual processing (S430) (dequantization and inverse transform of the quantized transform coefficient) described in the present disclosure. A modified reconstructed picture may be generated through the in-loop filtering procedure for the reconstructed picture generated through the picture reconstruction procedure, the modified reconstructed picture may be output as a decoded picture, stored in a decoded picture buffer or memory 250 of the decoding apparatus and used as a reference picture in the inter prediction procedure when decoding the picture later. In some cases, the in-loop filtering procedure may be omitted. In this case, the reconstructed picture may be output as a decoded picture, stored in a decoded picture buffer or memory 250 of the decoding apparatus, and used as a reference picture in the inter prediction procedure when decoding the picture later. The in-loop filtering procedure (S450) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, for example, after the deblocking filtering procedure is applied to the reconstructed picture, the ALF procedure may be performed. This may be similarly performed even in the encoding apparatus.

FIG. 5 shows an example of a schematic picture encoding procedure, to which embodiment(s) of the present disclosure is applicable.

Each procedure shown in FIG. 5 may be performed by the image encoding apparatus of FIG. 2. For example, step S510 may be performed by the predictor including the intra predictor 185 and the inter predictor 180, step S520 may be performed by a residual processor 115, 120 and 130, and step S530 may be performed by the entropy encoder 190. Step S510 may include the inter/intra prediction procedure described in the present disclosure, step S520 may include the residual processing procedure described in the present disclosure, and step S530 may include the information encoding procedure described in the present disclosure.

Referring to FIG. 5, the picture encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture. The encoding apparatus may derive (modified) residual samples from a quantized transform coefficient through the dequantizer 140 and the inverse transformer 150, and generate the reconstructed picture based on the prediction samples which are output of step S510 and the (modified) residual samples. The reconstructed picture generated in this way may be equal to the reconstructed picture generated in the decoding apparatus. The modified reconstructed picture may be generated through the in-loop filtering procedure for the reconstructed picture. In this case, the modified reconstructed picture may be stored in the decoded picture buffer of a memory 170, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the decoding apparatus may perform the in-loop filtering procedure using the same method as the encoding apparatus based on the filtering related information.

Through such an in-loop filtering procedure, noise occurring during image/video coding, such as blocking artifact and ringing artifact, may be reduced and subjective/objective visual quality may be improved. In addition, by performing the in-loop filtering procedure in both the encoding apparatus and the decoding apparatus, the encoding apparatus and the decoding apparatus may derive the same prediction result, picture coding reliability may be increased and the amount of data to be transmitted for picture coding may be reduced.

As described above, the picture reconstruction procedure may be performed not only in the image decoding apparatus but also in the image encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. On the other hand, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component and the methods and embodiments of the present disclosure are applicable to both the luma component and the chroma component unless explicitly limited in the present disclosure.

### Example of Coding Layer Structure

A coded video/image according to the present disclosure may be processed, for example, according to a coding layer and structure which will be described below.

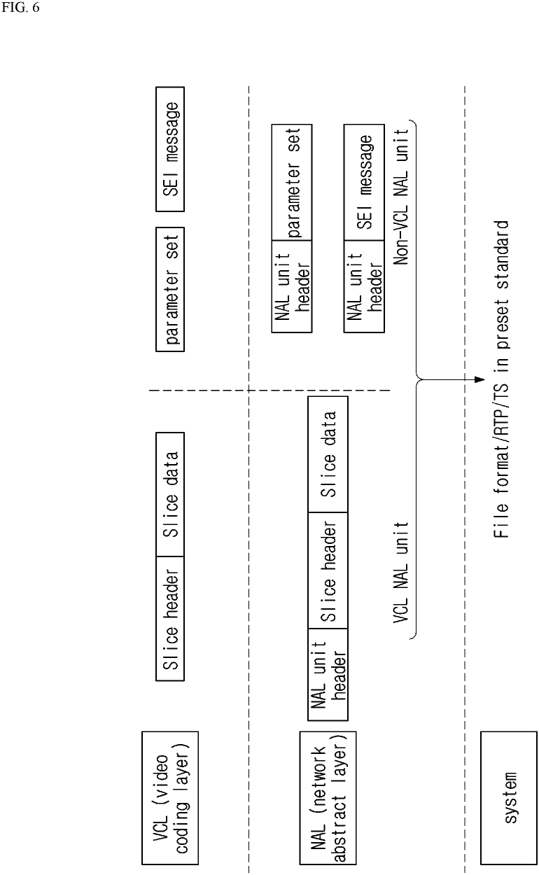

FIG. 6 is a view illustrating an example of a layer structure for a coded image/video.

The coded image/video is classified into a video coding layer (VCL) for an image/video decoding process and handling itself, a lower system for transmitting and storing encoded information, and a network abstraction layer (NAL) present between the VCL and the lower system and responsible for a network adaptation function.

In the VCL, VCL data including compressed image data (slice data) may be generated or a supplemental enhancement information (SEI) message additionally required for a decoding process of an image or a parameter set including information such as a picture parameter set (PPS), a sequence parameter set (SPS) or a video parameter set (VPS) may be generated.

In the NAL, header information (NAL unit header) may be added to a raw byte sequence payload (RBSP) generated in the VCL to generate a NAL unit. In this case, the RBSP refers to slice data, a parameter set, an SEI message generated in the VCL. The NAL unit header may include NAL unit type information specified according to RBSP data included in a corresponding NAL unit.

As shown in FIG. 6, the NAL unit may be classified into a VCL NAL unit and a non-VCL NAL unit according to the type of the RBSP generated in the VCL. The VCL NAL unit may mean a NAL unit including information on an image (slice data), and the Non-VCL NAL unit may mean a NAL unit including information (parameter set or SEI message) required to decode an image.

The VCL NAL unit and the Non-VCL NAL unit may be attached with header information and transmitted through a network according to the data standard of the lower system. For example, the NAL unit may be modified into a data format of a predetermined standard, such as H.266/VVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signaled. For example, this may be largely classified into a VCL NAL unit type and a non-VCL NAL unit type depending on whether the NAL unit includes information on an image (slice data). The VCL NAL unit type may be classified according to the property and type of the picture included in the VCL NAL unit, and the Non-VCL NAL unit type may be classified according to the type of a parameter set.

An example of the NAL unit type specified according to the type of the parameter set/information included in the Non-VCL NAL unit type will be listed below.
DCI (Decoding capability information) NAL unit type (NUT) : Type for NAL unit including DCI
VPS(Video Parameter Set) NUT: Type for NAL unit including VPS
SPS(Sequence Parameter Set) NUT : Type for NAL unit including SPS
PPS(Picture Parameter Set) NUT : Type for NAL unit including PPS
APS (Adaptation Parameter Set) NUT : Type for NAL unit including APS
PH (Picture header) NUT : Type for NAL unit including a picture header

The above-described NAL unit types may have syntax information for a NAL unit type, and the syntax information may be stored in a NAL unit header and signaled. For example, the syntax information may be nal_unit_type, and the NAL unit types may be specified using nal_unit_type values.

Meanwhile, one picture may include a plurality of slices, and one slice may include a slice header and slice data. In this case, one picture header may be further added to a plurality of slices (slice header and slice data set) in one picture. The picture header (picture header syntax) may include information/parameters commonly applicable to the picture. The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may information/parameters commonly applicable to multiple layers. The DCI (DCI syntax) may include information/parameters related to decoding capability.

In the present disclosure, a high level syntax (HLS) may include at least one of the APS syntax, the PPS syntax, the SPS syntax, the VPS syntax, the DCI syntax, the picture header syntax or the slice header syntax. In addition, in the present disclosure, a low level syntax (LLS) may include, for example, a slice data syntax, a CTU syntax, a coding unit syntax, a transform unit syntax, etc.

In the present disclosure, image/video information encoded in the encoding apparatus and signaled to the decoding apparatus in the form of a bitstream may include not only in-picture partitioning related information, intra/inter prediction information, residual information, in-loop filtering information but also information on the slice header, information on the picture header, information on the APS, information on the PPS, information on the SPS, information on the VPS and/or information on the DCI. In addition, the image/video information may further include general constraint information and/or information on a NAL unit header.

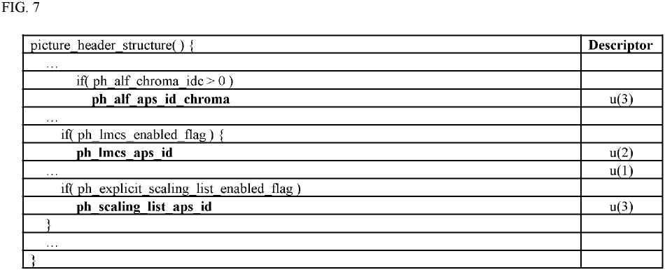

FIG. 7 is a view illustrating an example of a syntax structure for signaling information on an APS and a picture header. Image information may include a high level syntax (HLS). An image coding method may be performed based on the image information. A coded picture may consist of one or more slices. A parameter describing the coded picture may be signaled in a picture header. A parameter describing a slice may be signaled in a slice header. The picture header may be carried in a NAL unit type. The slice header may be present at a beginning part of the NAL unit including the payload of the slice. Luma mapping with chroma scaling (LMCS) may be a term including a luma mapping process and a chroma scaling process. For example, the luma mapping process and/or the chroma scaling process may be performed before in-loop filtering. For example, the luma mapping process may be performed with respect to a prediction block of a current luma block to generate a prediction block having a changed dynamic range. In this case, the current luma block may be reconstructed based on the prediction block having the changed dynamic range. In addition, for example, the chroma scaling process may be a process of scaling a chroma component residual signal based on a relationship between a luma component signal and a chroma component signal. In this case, a current chroma block may be reconstructed based on the scaled chroma component residual signal.

Referring to FIG. 7, information (e.g., ph_alf_aps_id_chroma) specifying the APS identifier of an ALF APS referenced by a chroma element of a slice in a current picture may be signaled. Information (e.g., ph_lmcs_aps _id) specifying an APS identifier of an LMCS APS referenced by a chroma element of a slice in a current picture may be signaled. In addition, information (e.g., ph_scaling _list aps _id) specifying an APS identifier of an APS scaling list may be signaled.

### Video Parameter Set Signalling

For a multi-layer bitstream having inter-layer dependency, an available set of layers may be decoded. A video parameter set (VPS) is a parameter set used to transmit layer information. The layer information may include, for example, information on an output layer set (OLS), information on a profile tier level, information on a relationship between the OLS and a hypothetical reference decoder, information on a relationship between the OLS and a DPB, etc.

VPS RBSP (raw byte sequence payload) may be included in at least one access unit (AU) having TemporalID of 0 or provided through an external means, before being referenced, thereby being available for a decoding process. All VPS NAL units having vps _video_parameter_set_ id of a specific value in the CVS shall have the same content.

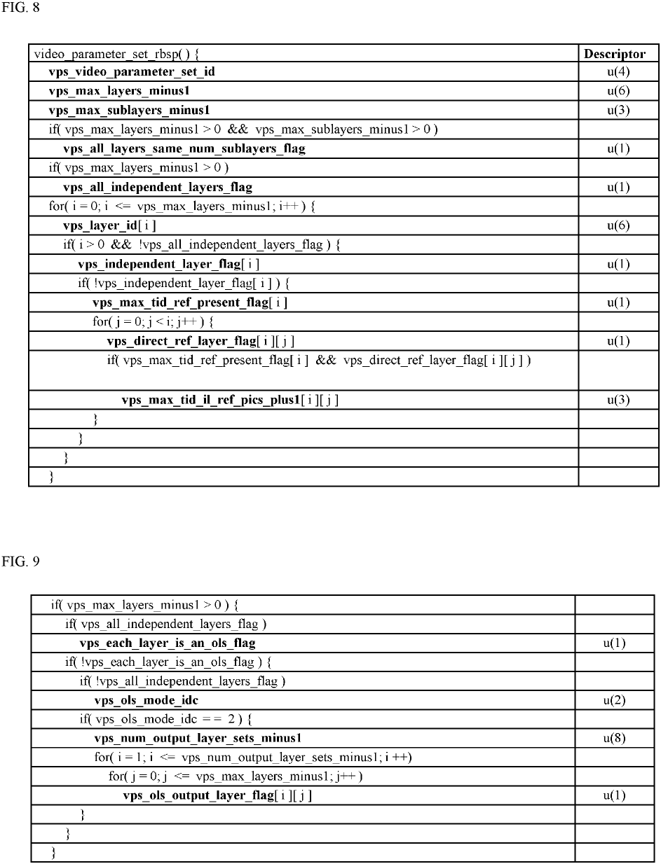

Syntax continuously illustrated in FIGS. 8 and 9 exemplarily shows the syntax structure according to an embodiment of the present disclosure. Hereinafter, the syntax elements of FIGS. 8 to 9 will be described.

vps_video_parameter_set_id provides an identifier for a VPS to be referenced by another syntax element. Other syntax elements may reference the VPS using vps_video_parameter_set_id. The value of vps _video_parameter_set_id shall be greater than 0.

vps_max_layers_minus1 may specify a maximum allowable number of layers present in an individual CVS referencing the VPS. For example, a value obtained by adding 1 to vps_max_layers_minus1 may specify a maximum allowable number of layers present in an individual CVS referencing the VPS.

A value obtained by adding 1 to vps_max_sublayers_minus1 may specify a maximum number of temporal sublayers which may be present in a layer in an individual CVS referencing the VPS.

A value 1 of vps_all_layers _same _num_sublayers _flag may specify that the number of temporal sublayers is the same in all layers in an individual CVS referencing the VPS. A value 0 of vps _all _layers _same num_sublayers _flag may specify that the number of temporal sublayers may or may not be the same in layers in an individual CVS referencing the VPS. When the value of vps _all _layers _same _num_sublayers _flag is not provided in the bitstream, the value of vps _all _layers _same _num_sublayers _flag may be derived as 1.

A value 1 of vps _all independent _layers _flag may specify that all layers belonging to the CVS is independently encoded without using inter layer prediction. A value 0 of vps_all_independent_layers_flag may specify that at least one layer belonging to the CVS may be encoded using inter layer prediction.

vps_layer_id[i ] may specify a nuh_layer_id value of an i-th layer. For any two non-negative integer values m and n, when m is less than n, vps layer_id[m] may be constrained to have a value less than vps layer_id[n]. Here, nuh layer_id is a syntax element signaled in a NAL unit header, and may specify an identifier of the NAL unit.

A value 1 of vps_independent layer_flag[ i ] may specify that inter layer prediction is not applied to a layer corresponding to an index i. A value 0 of vps_independent layer_flag[ i ] may specify that inter layer prediction is applicable to the layer corresponding to the index i, and a syntax element vps_direct_ref_layer_flag[ i ][ j ] is obtained from the VPS. Here, j may have a value from 0 to i-1. Meanwhile, when the value of vps _independent layer _flag[ i ] is not present in the bitstream, the value thereof may be derived as 1.

A value 1 of vps_max_tid_ref_present_flag[ i ] may specify that a syntax element vps_max_tid_il_ref_pics_plus1[ i ][ j ] is provided from a bitstream. A value 0 of vps_max_tid_ref^{_}present_flag[ i ] may specify that a syntax element vps_max_tid_il_ref_pics_plus1[ i ][ j ] is not provided from a bitstream.

A value 0 of vps_direct_ref_ layer_flag[ i ][ j ] may specify that a layer having an index j is not a direct reference layer of the layer having the index i. A value 1 of vps_direct_ref_layer_flag[ i ][ j ] may specify that layer having an index j is a direct reference layer of the layer having the index i. For i and j having a range from 0 to vps_max _layers _minus1, when the value of vps_direct_ref_layer _flag[ i ][ j ] is not obtained from a bitstream, the value thereof may be derived as 0. When the value of vps _independent layer _flag[ i ] is 0, at least one j which makes the value of vps_direct_ref_layer _flag[ i ][ j ] equal to 1 may be present. In this case, the range of the value of j may have a range from 0 to i-1.

Variables NumDirectRefLayers[ i ], DirectRefLayerIdx[ i ][ d ], NumRefLayers[ i ], RefLayerIdx[ i ][ r ], and LayerUsedAsRefLayerFlag[ j ] may be derived as shown in FIG. 10.

A variable GeneralLayerIdx[ i ] specifies a layer index of a layer in which the value of nuh_layer_id is the same as vps_layer_id[i ] and may be derived as shown in FIG. 11.

A value 0 of vps_max_tid__il_ref_pics_plus1 [ i ][ j ] may specify that a picture of a j-th layer which is neither a GDR picture nor an IRAP picture with 0 as a value of a syntax element ph_recovery_poc_cnt specifying a recovery point of a decoded picture is not used as an inter layer reference picture to decode pictures of an i-th layer. A value greater than 0 of vps_max_tid_il_ref_pics_plus1[ i ][ j ] may specify that a picture having TemporalId greater than vps_max_tid_il_ref_pics_plus1[ i ][ j ] - 1 in the j-th layer is not used as an inter layer reference picture to decode a picture of the i-th layer. Meanwhile, when the value of vps_max_tid_il_ref_pics_plus1[ i ][ j ] is not obtained from a bitstream, the value thereof may be derived as vps_max_sublayers_minus1 + 1.

A value 1 of vps_each_layer_is_an_ols_flag may specify that an individual OLS has only one layer and an individual layer belonging to a CVS referencing a VPS is an OLS having a single containing layer which is only one output layer. A value 0 of vps_each_layer_is_an_ols_flag may specify that the OLS may contain more than one layer. In an embodiment, when the value of vps_max_layers_minus1 is 0, the value of vps_each_layer_is_an_ols_flag may be derived as 1. Otherwise, when the value of vps_all_independent_layers_flag is 0, the value of vps_each_layer_is_an_ols_flag may be derived as 0.

A value 0 of vps_ols_mode_idc may specify that a total number of OLSs specified by the VPS is equal to vps_max_layers _minus1 + 1. An i-th OLS may include a layer having a layer index from 0 to i. In addition, for an individual OLS, the highest layer of the OLS may be output.

A value 1 of vps_ols_mode_idc may specify that a total number of OLSs specified by the VPS is equal to vps max_layers _minus1 + 1. An i-th OLS may include a layer having a layer index from 0 to i. In addition, for an individual OLS, all layers of the OLS may be output.

A value 2 of vps_ols_mode_idc may specify that a total number of OLSs specified by the VPS is explicitly signaled, an output layer is explicitly signaled for an individual OLS, and another layer is a direct or reference layer of the output layer of the OLS.

vps_ols_mode_idc may have a value from 0 to 2. A value 3 of vps_olsmode__idc may be reserved for future use. When the value of vps_all_independent _layers _flag is 1 and the value of vps_each_layer_is_an_ols_flag is 0, the value of vps_ols_mode_idc may be derived as 2.

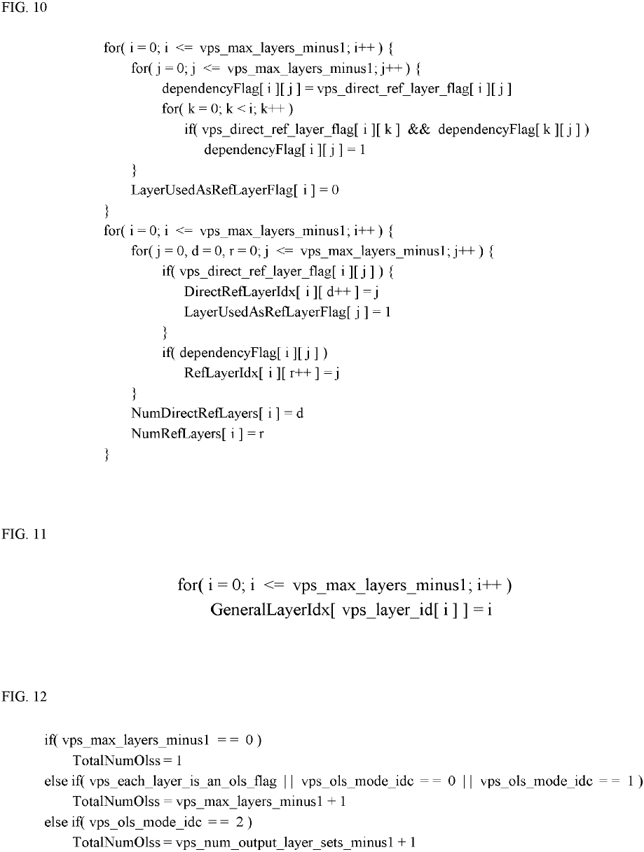

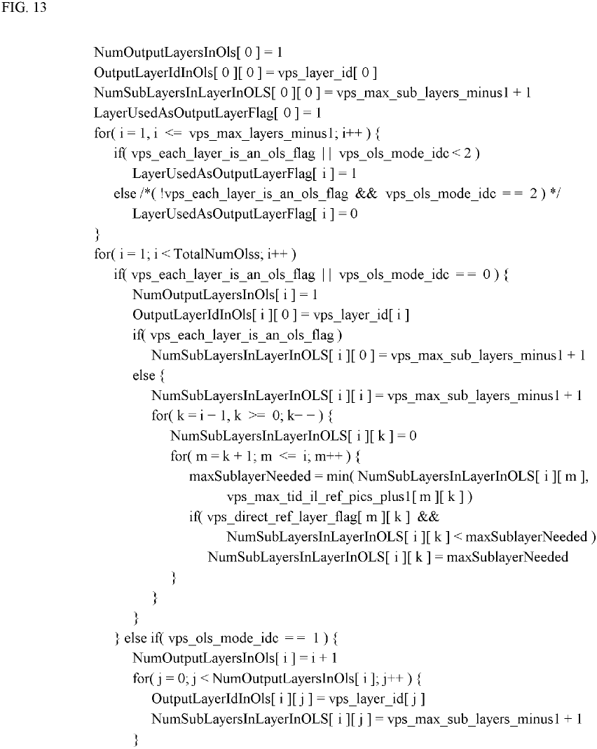

A value obtained by adding 1 to vps_num_output layer_sets_minus1 may specify a total number of OLSs specified by the VPS when the value of vps_ols_modeidc is a predetermined value (e.g. when the value is 2). A variable TotalNumOlss specifying a total number of OLSs specified by the VPS may be derived as shown in FIG. 12.

A value 1 of vps_ols_output_layer_flag[ i ][ j ] may specify that, when the value of vps_ols_mode_idc is 2, a layer in which the value of nuh_layer_id is equal to vps_layer_id[ j ] is an output layer of an i-th OLS. A value 0 of vps_ols_output_layer_flag[ i ][ j ] may specify that, when the value of vps_ols_mode_idc is 2, a layer in which the value of nuh layer_id is equal to vps layer_id[j ] is not an output layer of an i-th OLS.

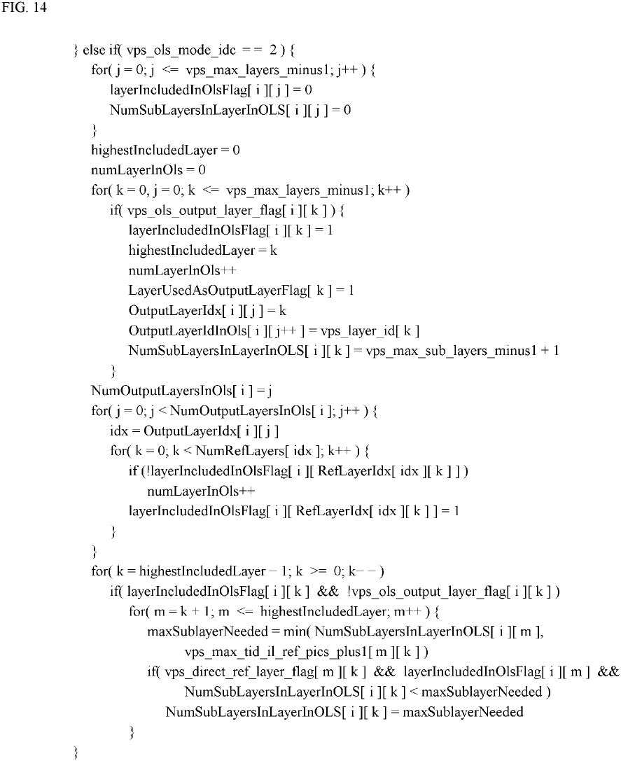

A variable NumOutputLayersInOls[ i ] specifying the number of output layers in the i-th OLS, a variable NumSubLayersInLayerInOLS[ i ][ j ] specifying the number of sublayers present in a j-th layer in the i-th OLS, a variable OutputLayerIdInOls[ i ][ j ] specifying a nuh_layer_id value of a j-th output layer in the i-th OLS, a variable LayerUsedAsOutputLayerFlag[ k ] specifying whether a k-th layer is used as one output layer in at least one OLS may be derived as a pseudo code continuously shown in FIGS. 13 to 14.

For each value from 0 to vps_max_layers_minus1, both the values of LayerUsedAsRefLayerFlag[ i ] and LayerUsedAsOutputLayerFlag[ i ] may be forced not to be 0. For example, a layer which is neither an output layer of at least one OLS nor a direct reference layer of another layer may be forced not to be present.

For each OLS, at least one layer which is an output layer may be forced to be present. For example, for each i value from 0 to TotalNumOlss - 1, the value of NumOutputLayersInOls[ i ] may be forced to have a value greater than or equal to 1.

A variable NumLayersInOls[ i ] specifying the number of layers in the i-th OLS and a variable LayerIdInOls[ i ][ j ] specifying a value of nuh_layer_id of a j-th layer in the i-th OLS,

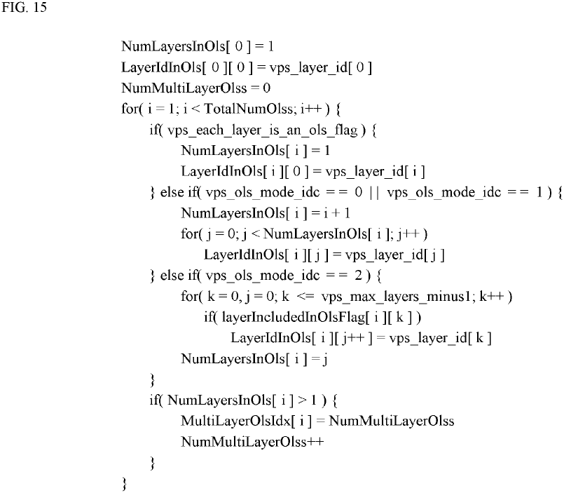

a variable NumMultiLayerOlss specifying the number of multi-layer OLSs (e.g., OLSs including one or more layers), and a variable MultiLayerOlsIdx[ i ] specifying an index for a list of multi-layer OLSs for the i-th OLS when the value of NumLayersInOls[ i ] is greater than 0 may be derived as the pseudo code of FIG. 15.

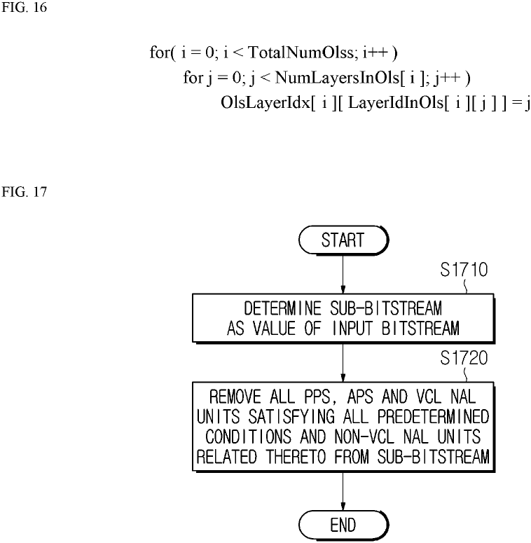

A variable OlsLayerIdx[ i ][ j ] specifying an OLS layer index of a layer having the same nuh_layer_id as LayerIdInOls[ i ][ j ] may be derived as the pseudo code of FIG. 16.

The lowest layer present in each OLS may be constrained to be an independent layer. For example, for each i having from 0 to TotalNumOlss - 1, the value of vps _independent layer_flag[ GeneralLayerIdx[ LayerIdInOls[ i ][ 0 ] ] ] may be forced to be 1. Each layer may be forced to be included in at least one OLS specified by the VPS.

### Improvement of APS Signalling

When it is not necessary to decode an output layer, in an extraction process, a VCL NAL unit having TemporalId equal to or less than a target maximum TemporalId may be removed from a non-output layer. However, APS NAL units present in such a layer and a temporal sublayer are not properly removed. Usually, in this case, a highest output layer does not use a VCL from the temporal sublayer and does not use a parameter set such as an APS and/or a PPS therefrom. Here, the APS may include adaptive loop filter (ALF) parameters, luma mapping with chroma scaling (LMCS) parameters or scaling list parameters, according to the APS type.

In order to solve the above-described problem, in the extraction process, the PPS and/or the APS may be selected as parameter sets which are not used as reference to decode pictures in output layers. In addition, in addition to the parameter sets, non-VCL NAL units which are not used as reference to perform decoding of pictures in the output layer in the extraction process may also be selected as being not used as reference to perform decoding of the pictures in the output layers in the extraction process. In addition, the APS may be prevented from being extracted from the output bitstream.

For such processing, the above-described syntax element vps_max_tid_il_ref_pics_plus1[ i ][ j ] may be redefined. For example, a first value (e.g., 0) of vps_max_tid_il_ref_pics_plus1[ i ][ j ] and may specify that a picture of a j-th layer which is neither a GDR picture nor an IRAP picture with 0 as a value of a ph_recovery_poc_cnt is not used as an inter layer reference picture to decode pictures of an i-th layer. A value greater than 0 of vps_max_tid_il_ref_pics_plus1 [ i ][ j ] may specify that a picture and parameter set having TemporalId greater than vps_max_tid_il_ref_pics_plus1[ i ][ j ] - 1 in a j-th layer is not used as reference, to decode the picture of the i-th layer. Meanwhile, when the value of vps_max_tid_il_ref_pics_plus1[ i ][ j ] is not obtained from a bitstream, the value thereof may be derived as vps_max_sublayers _minus1 + 1.

Meanwhile, a sub-bitstream may be derived according to the following a sub-bitstream extraction process. The sub-bitstream extraction process may take, as input, a variable inBitstream specifying an input bitstream, a target OLS index targetOlsIdx and tIdTarget which is a target TemporalId. A variable OutBitstream specifying an output sub-bitstream may be derived as follows.

First, a sub-bitstream may be determined as a value of an input bitstream (S1710). For example, a variable outBitstream specifying an output sub-bitstream may be set to be equal to a variable inBitstream specifying an input bitstream.

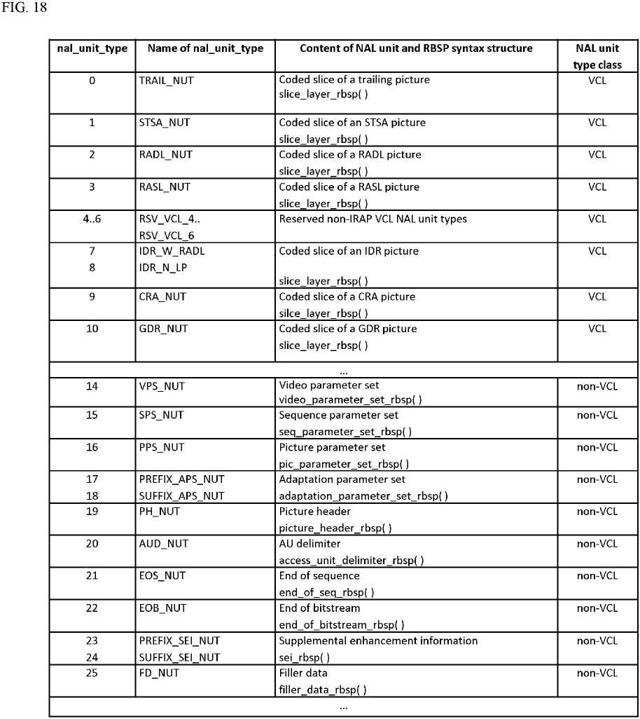

All PPS, APS and VCL NAL units satisfying all Conditions 1 to 3 below and non-VCL NAL units related thereto may be removed from outBitstream (S1720). Here, the non-VCL NAL units related thereto may be non-VCL NAL units having PayloadType other than 0, 1 or 130 and having nal_unit_type of any one of PH_NUT, FD_NUT, SUFFIX_SEI_NUT and PREFIX_SEI_NUT. FIG. 18 shows a NAL unit type.

(Condition 1) nal_unit_type of a VCL NAL unit is equal to TRAIL_NUT, STSA_NUT, RADL_NUT, or RASL_NUT, nal_unit_type is equal to GDR_NUT and ph_recovery_poc_cnt related thereto is not 0.

(Condition 2) nuh_layer_id is equal to LayerIdInOls[ targetOlsIdx ][ j ]. Here, j has a value from 0 to NumLayersInOls[ targetOlsIdx ] - 1.

(Condition 3) TemporalId has a value greater than or equal to NumSubLayersInLayerInOLS[ targetOlsIdx ][ GeneralLayerIdx[ nuh_layer_id ] ].

### Encoding and Decoding Method

Hereinafter, an image encoding method and an image decoding method performed by an image encoding apparatus and an image decoding apparatus according to an embodiment will be described. Operation of the decoding apparatus will be described first.

As described above, when vps_max_tid_il_ref_pics_plus1[ i ][ j ] has a value greater than 0, for inter layer prediction of an i-th layer (current layer), a picture and parameter set having TemporalId greater than vps_max_tid_il_ref_pics_plus1[ i ][j ] - 1 in a j-th layer (reference layer) may not be used as reference. In addition, as described with reference to FIGS. 14 and 15, NumSubLayersInLayerInOLS[ targetOlsIdx ][ GeneralLayerIdx[ nuh layer_id ] ] may be derived based on vps_max_tid_il_ref_pics_plus1[ i ][ j ]. Accordingly, a picture and parameter set having TemporalId equal to or greater than NumSubLayersInLayerInOLS[ targetOlsIdx ][ GeneralLayerIdx[ nuh_layer_id ] ] may not be used as reference for inter layer prediction of the current layer.

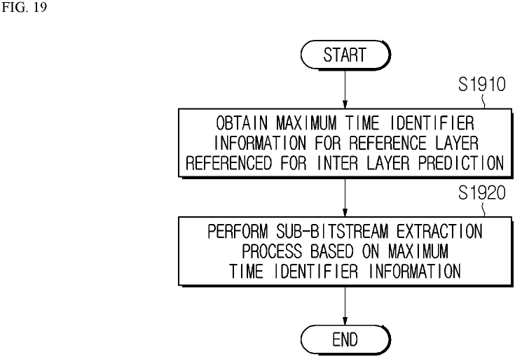

FIG. 19 is a view illustrating a method of decoding an image by an image decoding apparatus according to an embodiment. The image decoding apparatus according to the embodiment may include a memory and a processor, and the decoding apparatus may perform decoding by operation of the processor according to the embodiment described below.

The decoding apparatus according to the embodiment may obtain maximum time identifier information for inter layer prediction (S1910). Specifically, the decoding apparatus may obtain, from a bitstream, maximum time identifier information specifying a maximum time identifier of a reference layer referenced for inter layer prediction of a current layer. In the present disclosure, “being referenced for inter layer prediction of the current layer” may mean that “it may be referenced for inter layer prediction of the current layer”. Here, the maximum time identifier information may be the above-described syntax element vps_max_tid_il_ref_pics_plus1[i][j].

Next, the decoding apparatus may perform a sub-bitstream extraction process from a bitstream based on the maximum time identifier information (S1920). The decoding apparatus may remove a parameter set not referenced for inter layer prediction of the current layer among parameter sets of the reference layer, in the sub-bitstream extraction process of step S1920. Here, the parameter set may be an adaptive parameter set (APS).

Specifically, the decoding apparatus may derive NumSubLayersInLayerInOLS[ targetOlsIdx ][ GeneralLayerIdx[ nuh_layer_id ] ] based on the maximum time identifier information obtained from a bitstream. In this case, for example, the methods of FIGS. 13 and 14 may be used. The decoding apparatus may extract a sub-bitstream, from which a parameter set not referenced for inter layer prediction of a current layer is removed, among parameter sets of the reference layer, by performing the sub-bitstream extraction process described with reference to FIG. 17, based on the derived NumSubLayersInLayerInOLS.

The maximum time identifier information may specify a maximum time identifier of a reference layer referenced to decode a picture of the current layer. A parameter set having a time identifier greater than the maximum time identifier among the parameter sets of the reference layer may not be referenced to decode the picture of the current layer.

In addition, the maximum time identifier information may specify a maximum time identifier of a reference layer referenced to decode the picture of the current layer. A picture having a time identifier greater than the maximum time identifier among the pictures of the reference layer may not be referenced to decode the picture of the current layer.

Meanwhile, the decoding apparatus may further include a step of obtaining (extracting) a sub-bitstream from the bitstream based on the number of sublayers for the current layer. The sub-bitstream may be obtained by removing a predetermined parameter set from the bitstream, and the predetermined parameter set may be determined based on a size comparison between the time identifier of the predetermined parameter set and the number of sublayers determined for a layer corresponding to the predetermined parameter set. Here, the predetermined parameter set may be an adaptive parameter set (APS).

The predetermined parameter set may be determined based on whether the value of the time identifier of the predetermined parameter set is equal to or greater than a value corresponding to the number of sublayers determined for the layer corresponding to the predetermined parameter set among layers of a predetermined output layer set (OLS).

For example, whether the predetermined parameter set is removed may be determined, based on whether TemporalId has a value equal to or greater than NumSubLayersInLayerInOLS[ targetOlsIdx ][ GeneralLayerIdx[ nuh_layer_id ] ], for nuh_layer_id and TemporalId of the predetermined parameter set. In this case, NumSubLayersInLayerInOLS[ targetOlsIdx ][ GeneralLayerIdx[ nuh_layer_id ] ] may be derived by the method described in FIGS. 13 and 14. For example, NumSubLayersInLayerInOLS[ ][ ] may be derived based on vps_max_tid_il_ref_pics_plus1.

Meanwhile, the predetermined OLS may be any one of OLSs identified by information signaled by a video parameter set (VPS).

In the example described with reference to FIG. 19, the current layer may be an output layer and the reference layer may be a non-output layer.

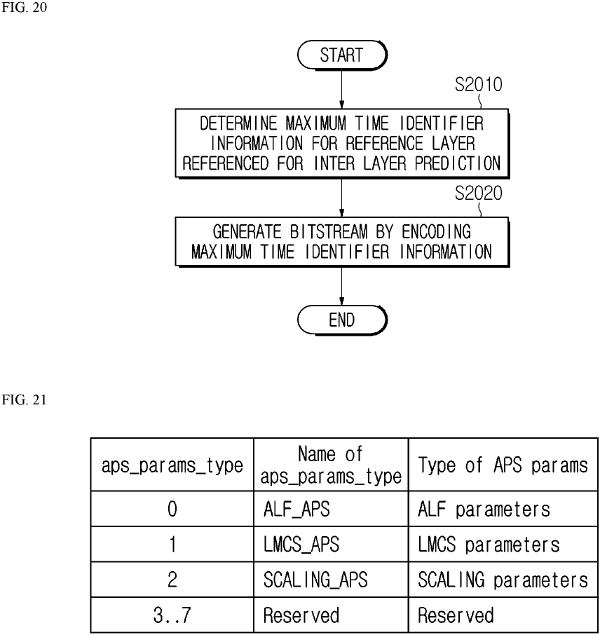

FIG. 20 is a view illustrating a method of encoding an image by an image encoding apparatus according to an embodiment. The image encoding apparatus according to the embodiment may include a memory and a processor, and the encoding apparatus may perform encoding by operation of the processor in a manner corresponding to decoding of the decoding apparatus according to the embodiment described below.

The encoding apparatus according to an embodiment may determine maximum time identifier information based on a maximum time identifier for inter layer prediction (S2010). Specifically, the encoding apparatus may determine the maximum time identifier of a reference layer referenced for inter layer prediction of a current layer, and determine the maximum time identifier information specifying the determined maximum time identifier. In the present disclosure, “being referenced for inter layer prediction of the current layer” may mean that “it may be referenced for inter layer prediction of the current layer”.

Next, the encoding apparatus may generate a bitstream by encoding the maximum time identifier information specifying the maximum time identifier (S2020). Here, the maximum time identifier information may be the above-described syntax element vps_max_tid_il_ref_pics_plus1[i][j].

The maximum time identifier information may be used in a sub-bitstream extraction process. Specifically, the maximum time identifier information may be used to remove a parameter set not referenced for inter layer prediction of the current layer among the parameter sets of the reference layer. Here, the parameter set may be an adaptive parameter set (APS).

Specifically, based on the maximum time identifier information, NumSubLayersInLayerInOLS[ targetOlsIdx ][ GeneralLayerIdx[ nuh_layer_id ] ] may be derived. In this case, for example, the methods of FIGS. 13 and 14 may be used. In addition, by performing the sub-bitstream extraction process described with reference to FIG. 17 based on the derived NumSubLayersInLayerInOLS, a sub-bitstream, from which the parameter set not referenced for inter layer prediction of the current layer among the parameter sets of the reference layer is removed, may be extracted.

The maximum time identifier may specify a maximum time identifier value of the reference layer referenced to encode the picture of the current layer. A parameter set having a time identifier greater than the maximum time identifier among the parameter sets of the reference layer may not be referenced to encode the picture of the current layer.

In addition, the maximum time identifier may specify a maximum time identifier of the reference layer referenced to encode the picture of the current layer. A picture having a time identifier greater than the maximum time identifier among the pictures of the reference layer may not be referenced to encode the picture of the current layer.

Meanwhile, the sub-bitstream may be obtained (extracted) from the bitstream generated according to the encoding method based on the number of sublayers for the current layer. For example, the sub-bitstream may be obtained by removing a predetermined parameter set from the bitstream. In addition, the predetermined parameter set may be determined based on a size comparison between the time identifier of the predetermined parameter set and the number of sublayers determined for a layer corresponding to the predetermined parameter set. Here, the predetermined parameter set may be an adaptive parameter set (APS).

For example, the predetermined parameter set may be determined based on whether the value of the time identifier of the predetermined parameter set is equal to or greater than a value corresponding to the number of sublayers determined for the layer corresponding to the predetermined parameter set among layers of a predetermined output layer set (OLS).

For example, whether the predetermined parameter set is removed may be determined, based on whether TemporalId has a value equal to or greater than NumSubLayersInLayerInOLS[ targetOlsIdx ][ GeneralLayerIdx[ nuh_layer_id ] ], for nuh_layer_id and TemporalId of the predetermined parameter set.

Meanwhile, the predetermined OLS may be any one of OLSs identified by information signaled by a video parameter set (VPS).

In the example described with reference to FIG. 20, the current layer may be an output layer and the reference layer may be a non-output layer.

As described above, based on maximum time identifier information specifying a maximum time identifier of a reference layer referenced for inter layer prediction of the current layer, an adaptive parameter set (APS) which is a parameter set not referenced for inter layer prediction of the current layer among the parameter sets of the reference layer may be removed. The image encoding apparatus or the image decoding apparatus may encode/decode the sub-bitstream extracted by removing the parameter set which is not referenced. In this case, the image encoding/decoding apparatus may perform encoding/decoding by referencing the APS included in the extracted sub-bitstream. Hereinafter, a method of signaling/parsing the APS by the image encoding/decoding apparatus according to the present disclosure will be described.

For the above-described encoding and decoding method, according to another embodiment of the present disclosure, a method of signaling APS identifier information may be improved based on an APS parameter type. FIG. 21 is a view illustrating an APS parameter name according to an APS parameter type.

Referring to FIG. 21, information (e.g., aps_params_type) specifying a type of an APS parameter transmitted in the APS may be signaled. The range of a value of aps_params_type may correspond to a range from 0 to 7 in a bitstream. When the value of aps_params_type is 0, the name of aps_params_type may correspond to ALF_APS and the type of the APS parameter may correspond to an ALF parameter. When the value of aps_params_type is 1, the name of aps_params_type may correspond to LMCS_APS and the type of the APS parameter may correspond to an LMCS parameter. When the aps_params_type is 2, the name of aps_params_type may correspond to SCALING_APS and the type of the APS parameter may correspond to a scaling list parameter. When the value of aps_params_type is a value from 3 to 7, aps_params_type may be reserved for future use.

FIG. 22 is a view illustrating an example of a syntax structure for signaling APS identifier information according to an APS parameter type. In an embodiment, in VVC, the range of the APS identifier may vary according to the APS type. For example, in case of an ALF APS and a scaling list APS, the range of the APS identifier may correspond to a range from 0 to 7. In case of the LMCS APS, the range of the APS identifier may correspond to a range from 0 to 3. Accordingly, instead of signaling the APS identifier with a fixed length, it may be signaled with a required number of bits according to the APS type.

Referring to FIG. 22, after information (e.g., aps_params_type) specifying the type of the APS parameter transmitted in the APS is signaled, information (e.g., aps_adaptation_parameter_set_id) specifying the APS identifier may be signaled. aps_adaptation_parameter_set_id may provide an identifier for the APS to be referenced in another syntax element. When aps_params_type is equal to ALF_APS or SCALING_APS, the length of aps_adaptation_parameter_set_id may correspond to 3 bits. In addition, when aps_params_type is LMCS_APS, the length of aps_adaptation_parameter_set_id may correspond to 2 bits. apsLayerId may be set to a nuh_layer_id value of a specific APS NAL unit, and vclLayerId may be set to a nuh_layer_id value of a specific VCL NAL unit. The specific VCL NAL unit may not reference the specific APS NAL unit until apsLayerId is less than or equal to vclLayerId. In addition, all OLSs specified in the VPS including a layer in which nuh layer_id is equal to vclLayerId may include a layer in which nuh_layer_id is equal to apslayerId.

According to another embodiment of the present disclosure, all APS NAL units having a specific value of aps_params_type and whether it is a prefix or suffix APS NAL unit may share the same value space for aps_adaptation_parameter_set_id, regardless of a nuh_layer_id. APS NAL units having different values of aps_params_type may use a separate value space for aps_adaptation_parameter_set_id. When aps_params_type is ALF_APS or SCALING APS, the value of aps_adaptation_parameter_set_id may correspond to a range from 0 to 7. When aps_params_type is LMCS_APS, the value of aps_adaptation_parameter_set_id may correspond to a range from 0 to 3.

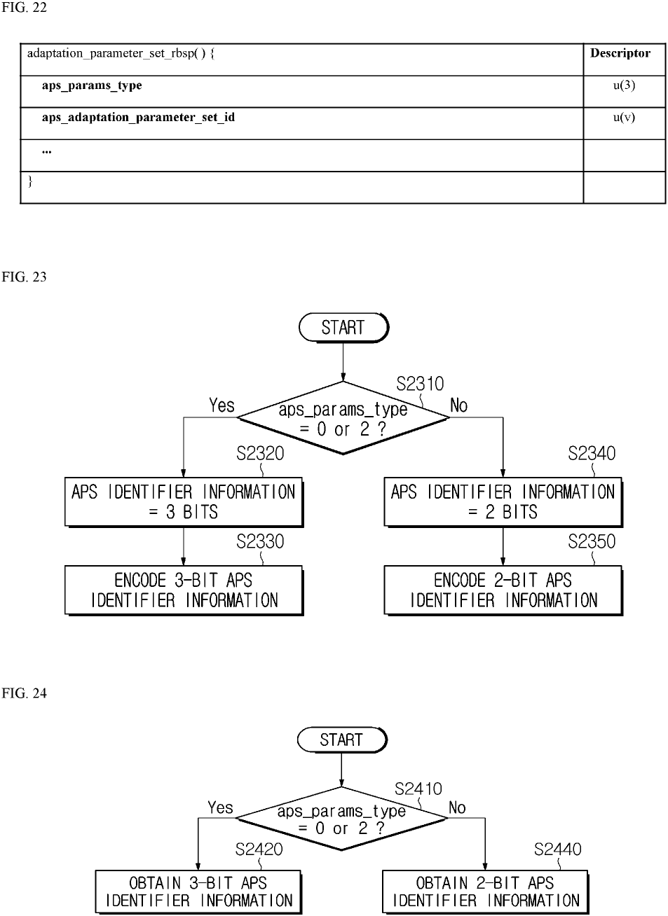

FIG. 23 is a view illustrating operation of the image encoding apparatus according to the embodiment described with reference to FIG. 22. Information related to the APS identifier may include at least one of the value of the APS identifier or the range of the APS identifier. The range of the APS identifier may be expressed by the number of bits.

Referring to FIG. 23, whether aps_params_type corresponds to 0 or 2 may be determined (S2310). When the above condition is satisfied (S2310-YES), the bit length of the APS identifier information (e.g., aps_adaptation_parameter set_id) may be set to a length of 3 bits (S2320). In addition, 3-bit APS identifier information (e.g., aps_adaptation_parameter_set_id) may be encoded (S2330). In addition, the range of the value of the APS identifier information (e.g., aps_adaptation_parameter_setid) may be set to a range from 0 to 7. In addition, the APS identifier information (e.g., aps_adaptation_parameter_set_id) may be encoded as any one value in a range from 0 to 7.

When the condition of step S2310 is not satisfied (S2310-NO), that is, when aps_params_type does not correspond to 0 or 2, the bit length of the APS identifier information (e.g., aps_adaptation_parameter_set_id) may be set to a length of 2 bits (S2340). In addition, 2-bit identifier information (e.g., aps_adaptation_parameter_set_id) may be encoded (S2350). Therefore, the range of the value of the APS identifier information (e.g., aps_adaptation_parameter_set_id) may be set to a range of a value from 0 to 3. In addition, the APS identifier information (e.g., aps_adaptation_parameter_set_id) may be encoded as any one value in a range from 0 to 3.

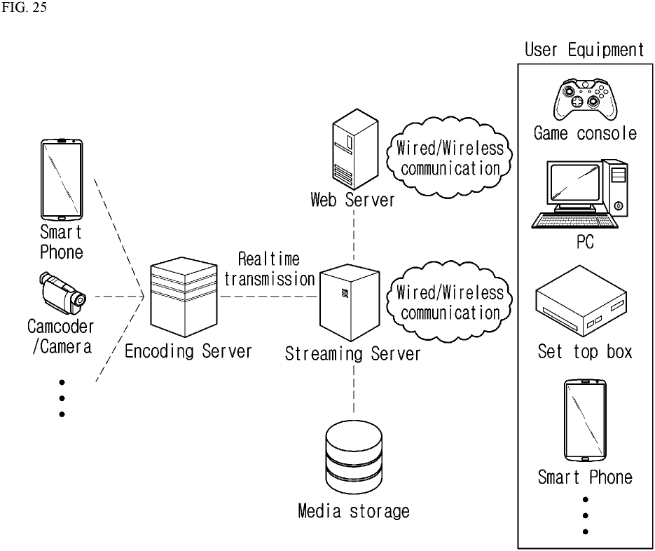

FIG. 24 is a view illustrating operation of an image decoding apparatus according to the embodiment described with reference to FIG. 22.

Referring to FIG. 24, whether aps_params_type corresponds to 0 or 2 may be determined (S2410). When the condition is satisfied (S2410-YES), 3-bit APS identifier information (e.g., aps_adaptation_parameter_set_id) may be obtained (S2420). Therefore, the range of the value of the APS identifier information (e.g., aps_adaptation_parameter_set_id) may be obtained as a range of the value from 0 to 7. In this case, an image may be reconstructed based on the value of the APS identifier information (e.g., aps_adaptation_parameter_set_id) from 0 to 7 (not shown).

When the condition of step S2410 is not satisfied (S2410-NO), that is, when aps_params_type does not correspond to 0 or 2, 2-bit APS identifier information (e.g., aps_adaptation_parameter_set_id) may be obtained (S2430). Therefore, the range of the value of the APS identifier information (e.g., aps_adaptation_parameter_set_id) may be obtained as a range from 0 to 3. In this case, an image may be reconstructed based on the value of the APS identifier information (e.g., aps_adaptation_parameter_set_id) of 0 to 3 (not shown).

Meanwhile, for the above-described encoding and decoding method, according to another embodiment of the present disclosure, when nal_unit_type is equal to DCI_NUT, VPS_NUT, PREFIX APS NUT, SUFFIX_APS_NUT, PPS_NUT or SPS_NUT, it may be forced such that TemporalId is equal to 0 and TemporalId of an AU including NAL units is equal to 0.

In addition, according to another embodiment of the present disclosure, an output bitstream may be set to be equal to an input bitstream. All VCL NAL units having TemporalId greater than tIdTarget may be removed from the output bitstream. Associated non-VCL NAL units having the same nal_unit_type as PH_NUT, FD_NUT and SUFFIX_SEI_NUT may be removed from the output bitstream. PREFIX_SEI_NUT in which PayloadType is not 0, 1 or 130 may be removed from the output bitstream. All NAL units in which nal_unit_type is not equal to VPS_NUT or DCI_NUT may be removed from the output bitstream. nuh_layer_id not included in EOB_NUT and LayerIdInOls [targetOlsIdx] may be removed from the output bitstream.

When the following conditions are satisfied, all VCL NAL units may be removed from the output bitstream. When the following conditions are satisfied, associated non-VCL NAL units having the same nal_unit_type as PH_NUT, FD_NUT and SUFFIX_SEI_NUT may be removed from the output bitstream. When the following conditions are satisfied, PREFIX_SEI_NUT in which PayloadType is not 0, 1 or 130 may be removed from the output bitstream.

Condition 1: nal_unit_type is equal to TRAIL_NUT, STSA_NUT, RADL_NUT or RASL_NUT, or nal_unit_type is equal to GDR_NUT and associated ph_recovery_poc_cnt is not 0.

Condition 2: nuh layer_id is equal to LayerIdInOls [targetOlsIdx] [j] for j in a range from 0 to NumLayersInOls [targetOlsIdx] - 1.

Condition 3: TemporalId is greater than or equal to NumSubLayersInLayerInOLS [targetOlsIdx] [GeneralLayerIdx [nuh layer_id]]

### Application Embodiment

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

FIG. 25 is a view illustrating a content streaming system, to which an embodiment of the present disclosure is applicable.

As shown in FIG. 25, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user’s request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
obtaining adaptive parameter set (APS) parameter type information specifying an APS parameter type signaled by an APS;
obtaining APS identifier information specifying the APS after obtaining the APS parameter type information; and
reconstructing an image based on the APS identifier information.

2. The image decoding method of claim 1, wherein, based on a value of the APS parameter type information being 0, the APS parameter type is determined to be an all loop filter (ALF) parameter type.

3. The image decoding method of claim 1, wherein, based on a value of the APS parameter type information being 1, the APS parameter type is determined to be a luma mapping with chroma scaling (LMCS) parameter type.

4. The image decoding method of claim 1, wherein, based on a value of the APS parameter type information being 2, the APS parameter type is determined to be a scaling list parameter type.

5. The image decoding method of claim 1, wherein, based on the APS parameter type being an all loop filter (ALF) parameter or a scaling list parameter, an APS identifier is determined to be a value in a range from 0 to 7.

6. The image decoding method of claim 1, wherein, based on the APS parameter type being a luma mapping with chroma scaling (LMCS) parameter, an APS identifier is determined to be a value in a range from 0 to 3.

7. (canceled)

8. An image encoding method performed by an image encoding apparatus, the image encoding method comprising:
determining an adaptive parameter set (APS) parameter type;
determining an APS identifier specifying the APS based on the APS parameter type;
encoding APS identifier information specifying the APS identifier after encoding the APS parameter type information specifying the APS parameter type; and
encoding an image based on the APS identifier.

9. The image encoding method of claim 8, wherein, based on the APS parameter type being an all loop filter (ALF) parameter, a value of the APS parameter type information specifying the APS parameter type is determined to be 0.

10. The image encoding method of claim 8, wherein, based on the APS parameter type being a luma mapping with chroma scaling (LMCS) parameter, a value of the APS parameter type information specifying the APS parameter type is determined to be 1.

11. The image encoding method of claim 8, wherein, based on the APS parameter type being a scaling list parameter, a value of the APS parameter type information specifying the APS parameter type is determined to be 2.

12. The image encoding method of claim 8, wherein, based on the APS parameter type being an all loop filter (ALF) parameter or a scaling list parameter, an APS identifier is determined to be a value in a range from 0 to 3.

13. The image encoding method of claim 8, wherein, based on the APS parameter type being a luma mapping with chroma scaling (LMCS) parameter, an APS identifier is determined to be a value in a range from 0 to 7.

14. A non-transitory computer-readable recording medium storing a bitstream generated by the image encoding method of claim 8.

15. A method of transmitting a bitstream generated by an image encoding method, the image encoding method comprising:
determining an adaptive parameter set (APS) parameter type;
determining an APS identifier specifying the APS based on the APS parameter type;
encoding APS identifier information specifying the APS identifier after encoding the APS parameter type information specifying the APS parameter type; and
encoding an image based on the APS identifier.
